(19) United States
(12) Patent Application Publication
(10) Pub. No.: US 2014/0356162 A1
(43) Pub. Date: Dec. 4, 2014

(54) WIND POWER TURBINE AND WIND POWER TURBINE CONTROL METHOD

(71) Applicant: WILIC S.AR.L, Luxembourg (LU)

(72) Inventors: Alessandro Fasolo, Vipiteno (IT); Matthias Preindl, Rasun-Anterselva (IT); Mattia Scuotto, Vipiteno (IT); Thomas Kaessner, Dresden (DE)

(21) Appl. No.: 14/367,103

(22) PCT Filed: Dec. 24, 2012
(86) PCT No.: PCT/IB2012/057688

§ 371 Date: Jun. 19, 2014

(30) Foreign Application Priority Data
Dec. 23, 2011 (IT) MI2011A002385

(51) Int. Cl. F03D 9/00; F03D 7/02

(52) U.S. Cl. CPC F03D 9/002; F03D 7/02
USPC 416/1; 416/3

(57) ABSTRACT

A wind power turbine control method, the wind power turbine having an electric machine, in turn having a stator, a rotor rotatable about an axis of rotation with respect to the stator, and a mechanical bearing assembly configured to couple the rotor in rotary manner to the stator; the stator having at least one winding to interact electromagnetically with the rotor; and the control method including the steps of: estimating at least one quantity selected from a group including a distance between the rotor and the stator, the variation over time in the distance, and misalignment between the rotor and stator; defining a localized additional magnetic force as a function of the selected quantity; and regulating the selected quantity using the localized additional magnetic force defined.

### PRIORITY CLAIM

This application is a national stage application of PCT/IB2012/057688, filed on Dec. 24, 2012, which claims the benefit of and priority to Italian Patent Application No. MI2011A 002385, filed on Dec. 23, 2011, the entire contents of which are each incorporated by reference herein.

### BACKGROUND

Certain known stators of certain known wind power turbines comprise a stator cylinder, and stator segments arranged about the axis of rotation, along the stator cylinder. Likewise, certain known rotors of certain known wind power turbines comprise a rotor cylinder, and rotor segments arranged about the axis of rotation, along the rotor cylinder. The rotor cylinder is coupled to the stator cylinder by at least one mechanical bearing assembly, and is connected to the blade assembly.

These technical solutions provide for balanced weight distribution with respect to the supporting structure, and for particularly easy assembly. Magnetic forces of attraction having a radial component and mainly due to the ferromagnetic laminations in the stator and rotor packs, and torque-generating tangential magnetic forces act between the stator and rotor of an energized electric machine. And, in ideal geometric conditions, the resultant of the radial forces is nil.

The range of wind speeds over the swept surface of the blade assembly, however, not being distributed uniformly, may result in a non-homogeneous distribution of forces on the blade assembly, which, during normal operation, may be subjected to severe stress resulting in a tipping moment (perpendicular to the axis of rotation). The tipping moment is transmitted to the rotor of the electric generator, thus resulting in misalignment of the rotor and stator, which is also caused by the cantilevered assembly on the main bearing and the finite rigidity of the system as a whole.

Motion of the rotor with respect to the stator, as opposed to simple rotation about its axis, therefore becomes a complex motion composed of random components of rotation, translation (perpendicular to the axis), nutation and precession.

These drawbacks give rise to an unbalanced resultant radial force, and may therefore reduce the working life of the main mechanical bearing supporting the rotor. In addition, the air gap may be reduced to such an extent that the rotor and stator (i.e., the rotor and any emergency bearings fixed to the stator), eventually come into contact with one another, thus damaging the electric machine.

One solution to the problem is to reinforce the mechanical structure, but this has the drawback of increasing the weight of the nacelle.

### SUMMARY

The present disclosure relates to an electric energy producing wind power turbine and to a wind power turbine control method.

More specifically, the present disclosure relates to a wind power turbine comprising a supporting structure; a nacelle; a blade assembly which rotates with respect to the nacelle; and an electric machine comprising a stator and a rotor.

It is an advantage of the present disclosure to provide a wind power turbine control method configured to limit certain of the drawbacks of certain of the known art.

According to the present disclosure, there is provided a wind power turbine control method, the wind power turbine comprising an electric machine, in turn comprising a stator, a rotor rotatable about an axis of rotation with respect to the stator, and a mechanical bearing assembly configured to couple the rotor in rotary manner to the stator; the stator comprising at least one winding to interact electromagnetically with the rotor; and the control method comprising the steps of: estimating at least one quantity selected from a group comprising a distance between the rotor and the stator, the variation over time in said distance, misalignment between the rotor and stator, and the variation over time in said misalignment; defining a localized additional magnetic force as a function of the selected quantity; and regulating the selected quantity using the localized additional magnetic force defined.

The control method according to the present disclosure defines an additional magnetic force to reduce misalignment and so increase the working life of the mechanical bearing assembly, and also prevents the air gap from being reduced to the point of stopping the electric machine, thus ensuring greater continuity in the operation of the wind turbine.

It is a further advantage of the present disclosure to provide such a wind power turbine configured to limit certain of the drawbacks of certain of the known art.

It is a further advantage of the present disclosure to provide a wind power turbine configured to increase the working life of the mechanical bearing assembly.

According to the present disclosure, there is provided a wind power turbine comprising an electric machine, in turn comprising a stator, a rotor rotatable about an axis of rotation with respect to the stator, and a mechanical bearing assembly configured to couple the rotor in rotary manner to the stator; the stator comprising at least one winding to interact electromagnetically with the rotor; and the wind power turbine comprising a control device configured to: estimate a quantity selected from a group comprising a distance between the rotor and the stator, the variation over time in said distance, misalignment between the rotor and stator, and the variation over time in said misalignment; define a localized additional magnetic force as a function of the selected quantity; and regulate the selected quantity using the localized additional magnetic force defined.

The control device in the present disclosure determines a localized additional magnetic force to adjust the selected quantity and so increase the working life of the bearing assembly and prevent the air gap from being reduced to the point of stopping the electric machine.

Additional features and advantages are described in, and will be apparent from the following Detailed Description and the figures.

### BRIEF DESCRIPTION OF THE DRAWINGS

A number of non-limiting embodiments of the present disclosure will be described by way of example with reference to the attached drawings, in which:

FIG. 1 shows a side view of a wind power turbine;

FIG. 2 shows a schematic front view, with parts removed for clarity, of an electric machine of the FIG. 1 wind power turbine;

FIG. 3 shows a larger-scale detail of the wind power turbine electric machine;

FIG. 4 shows an operating block diagram of the FIG. 1 wind power turbine;

FIG. 5 shows a simplified detail of the wind power turbine electric machine in one operating configuration;

FIG. 6 shows a simplified detail of the wind power turbine electric machine in another operating configuration;

FIG. 7 shows a simplified detail of the wind power turbine electric machine in another operating configuration; and

FIG. 8 shows a simplified detail of the wind power turbine electric machine in another operating configuration.

### DETAILED DESCRIPTION

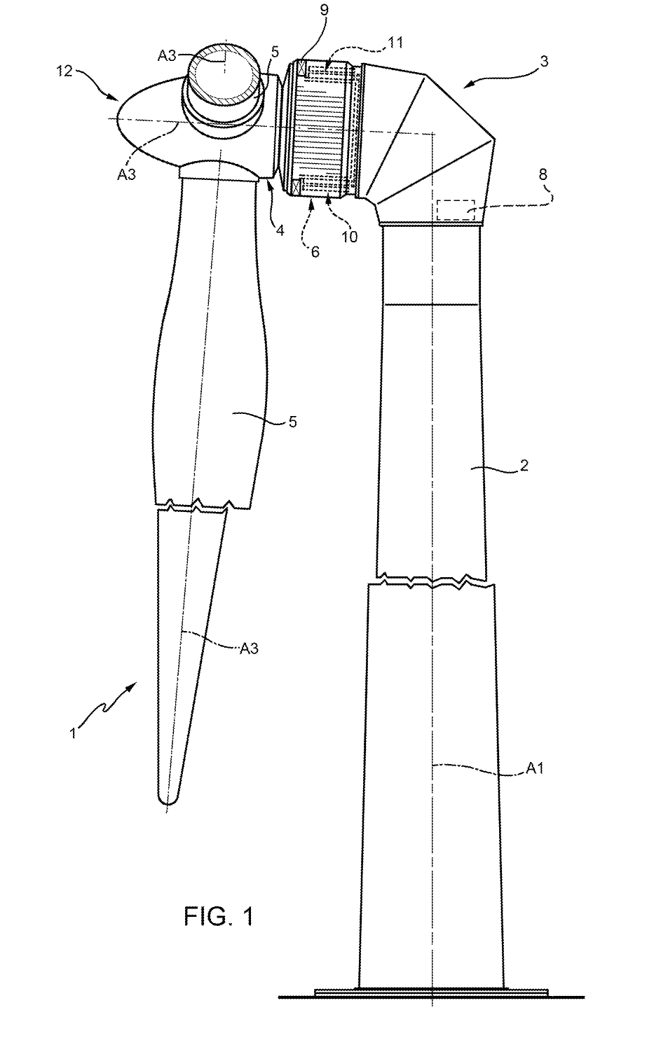

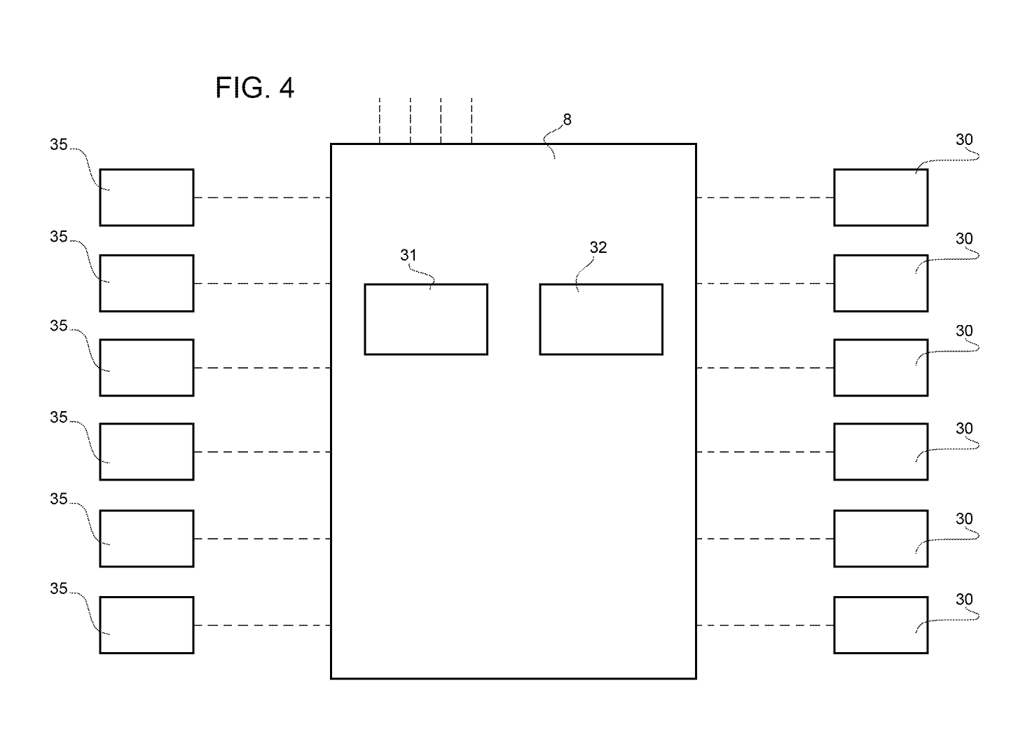

Referring now to the example embodiments of the present disclosure illustrated in FIGS. 1 to 8, number 1 in FIG. 1 indicates as a whole an electric energy producing wind power turbine.

In the FIG. 1 example, wind power turbine 1 is a direct-drive, variable-angular-speed wind turbine. Wind power turbine 1 comprises a supporting structure 2, a nacelle 3, a hub 4, three blades 5 (only two shown in FIG. 1), and an electric machine 6.

Blades 5 are fitted to hub 4, which is fitted to nacelle 3, in turn fitted to supporting structure 2.

Supporting structure 2 is a structural element supporting nacelle 3.

In a variation of the present disclosure (not shown), supporting structure 2 is an iron tower.

With reference to FIG. 1, nacelle 3 is mounted to rotate about an axis A1 with respect to supporting structure 2 to position blades 5 into the wind; hub 4 is mounted to rotate about an axis of rotation A2 with respect to nacelle 3; and each blade 5 is fitted to hub 4 to rotate about an axis A3 with respect to hub 4. Electric machine 6 comprises a stator 10; a rotor 11; and a mechanical bearing assembly 9 configured to couple rotor 11 to stator 10 in rotary manner about axis of rotation A2. Hub 4, blades 5 and rotor 11 define a rotary assembly 12, which rotates with respect to nacelle 3 about axis of rotation A2.

Rotor 11 is coaxial with stator 10.

With reference to the attached drawings, stator 10 comprises a stator cylinder 15; cooling fins 16 fixed to the outer face of stator cylinder 15; and a whole number of stator segments 18 arranged about axis of rotation A2 and fixed to the inner face of stator cylinder 15 by fasteners (not shown in the drawings). Each stator segment 18 comprises a quantity or number of—in the example shown, two—stator windings 17; and a quantity or number of—in the example shown, two—packs of stator laminations 19, each wound with a stator winding 17, which is associated with only one stator segment 18, so stator lamination can be extracted from stator 10 without interacting with the other stator segments 18. Stator cylinder 15 covers, protects and supports stator segments 18.

Rotor 11 comprises a rotor cylinder 20; rotor segments 21 arranged about axis of rotation A2; and cooling fins 22 fixed to the inner face of rotor cylinder 20.

Windings 17 of stator 10 are arranged in groups, in each of which the windings 17 are connected to each other, and between which flows a current with the same phase.

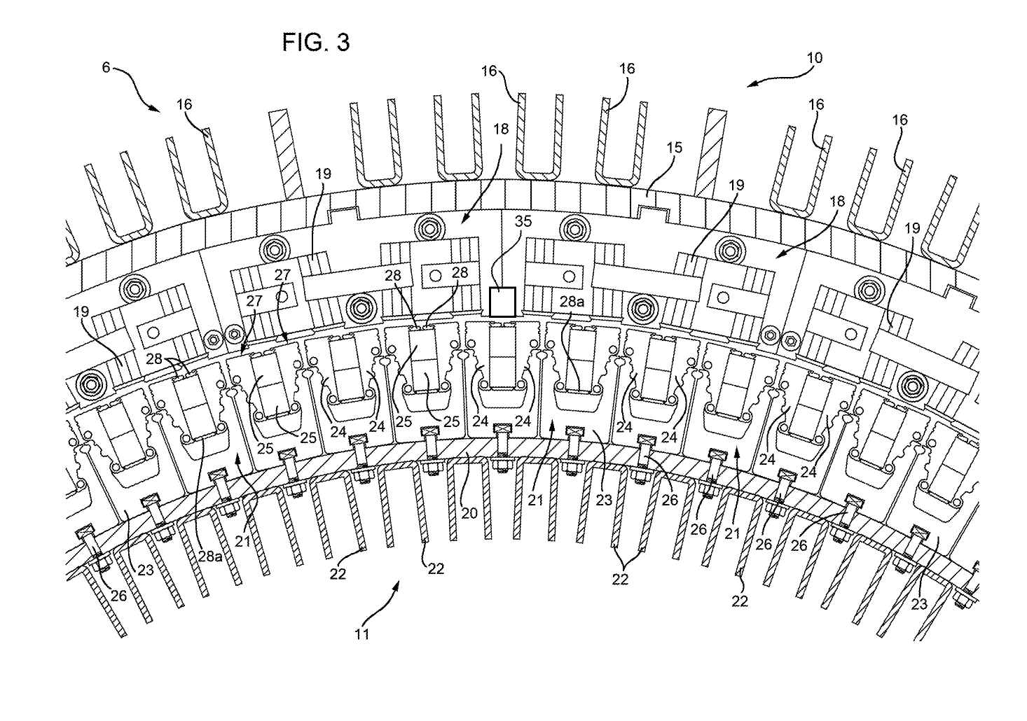

As shown in FIG. 3, each rotor segment 21 comprises a gripper 23, magnetic guides 24, magnetized modules 25, and fastening bolts 26.

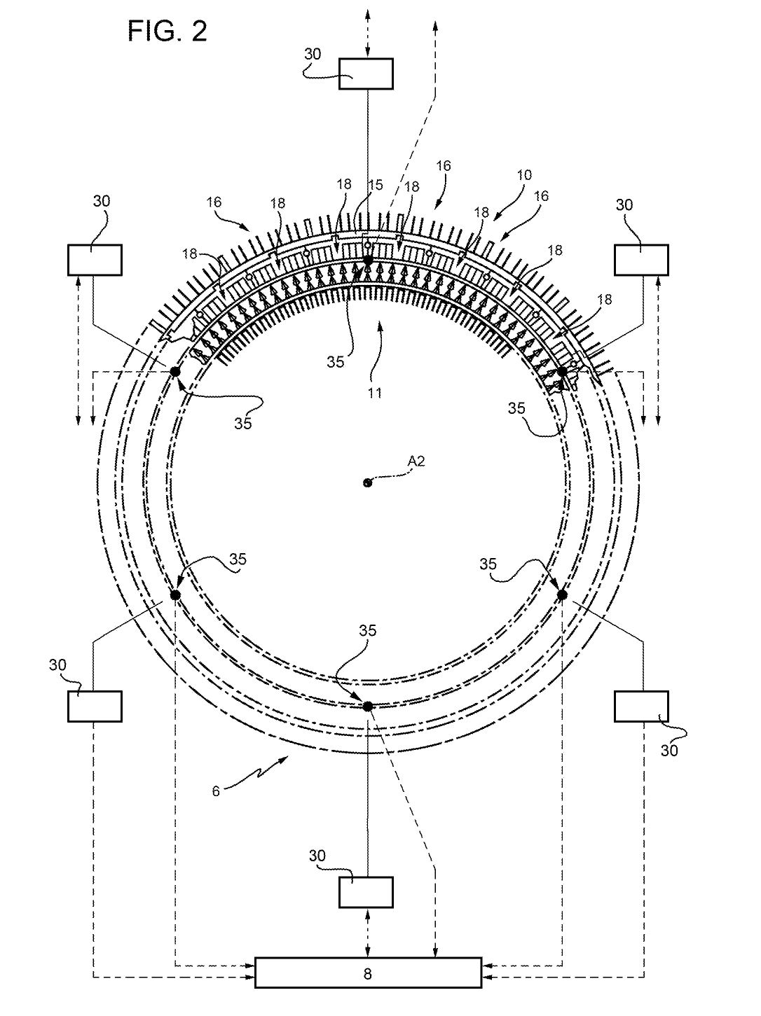

In each rotor segment 21, magnetized modules 25 are aligned radially to axis of rotation A2 (FIG. 2) into groups of modules 25, which in turn are arranged successively, parallel to axis of rotation A2 (FIG. 2), along the whole of rotor segment 21.

Rotor cylinder 20 is coupled to stator cylinder 15 by mechanical bearing assembly 9, so stator 10 and rotor 11 are separated by a volume of air or so-called air gap 29 extending between stator windings 17 and magnetized modules 25.

For each group of windings 17, wind power turbine 1 comprises an electric energy switch converter 30 connected to control device 8 and respective group of windings 17 to control the current of respective group of windings 17 as commanded by control device 8. Switch converter 30 comprises controlled switches (e.g., Power MOSFETS or IGBTs), or other power transistors.

Control device 8 is connected to windings 17 by respective switch converters 30 to control the current in windings 17 of stator 10. Control device 8 comprises a memory 31 storing the angular position of windings 17 coupled to each switch converter 30, so control device 8 can control the current and/or voltage of each group of windings 17; the electric phase (i.e., the phase shift between the current and/or voltage, of groups of windings 17); and the angular phase (i.e., the difference in position, of groups of windings 17).

Wind power turbine 1 comprises an angular position sensor (not shown) which supplies control device 8 with the absolute angular position of rotor 11 with respect to stator 10.

FIG. 2 shows, schematically, six switch converters 30, each coupled to a respective group of windings 17. Each switch converter 30 therefore controls respective group of windings 17, so this contributes independently to the total electromagnetic torque produced by electric machine 6, and to the magnetic excitation flux produced by rotor 11.

With reference to FIGS. 2 and 3, wind power turbine 1 comprises proximity sensors 35 on stator 10. Each proximity sensor 35 measures a distance, radially with respect to axis of rotation A2, between rotor 11 and stator 10 (i.e., a size of air gap 29 radially with respect to axis of rotation A2), and is coupled to control device 8. More specifically, proximity sensor 35 is located inside stator 10, between two stator segments 19, is positioned facing rotor 11, and supplies the minimum distance between stator 10 and rotor 11.

In an alternative embodiment of the present disclosure (not shown), the proximity sensors are located on the rotor, along the perimeter of the air gap, and along a portion of the rotor adjacent to the bearing assembly and/or to the nacelle.

Control device 8 receives the size of air gap 29 from proximity sensor 35, and an identification number identifying each proximity sensor 35.

Memory 31 of control device 8 contains the angular position of each proximity sensor 35 identified by its identification number. A processing unit 32 memorizes in memory 31 the dimensions of air gap 29 recorded by each proximity sensor 35, together with the times they were recorded, analyses the time pattern of the air gap dimensions at each measuring point, and determines movement of rotor 11 with respect to stator 10. More specifically, processing unit 32 determines each distance and/or the variation over time in each distance between rotor 11 and stator 10. In one embodiment, processing unit 32 calculates the acceleration of rotor 11 at each measuring point from the variation over time in each dimension of the air gap, and/or the acceleration of rotor 11 along axis of rotation A2 from the variation over time in the misalignment of rotor 11 and stator 10.

Control device 8 controls the current in groups of windings 17, to regulate the current from electric machine 6 and the resisting torque of electric machine 6 to rotation of rotary assembly 12, on the basis of operating parameters of wind power turbine 1, such as wind speed and the rotation speed of rotor 11, on the basis of commands from the operator of wind power turbine 1, and on the basis of a wind power turbine efficiency factor.

On the basis of the size and/or the variation over time in the size of air gap 29, control device 8 defines a localized additional magnetic force as a function of time and by which to regulate the size of air gap 29.

Control device 8 defines an additional current in winding 17 on the basis of the localized additional magnetic force defines, and controls the additional current in winding 17 using switch converters 30. More specifically, processing unit 32 calculates the additional current in winding 17 required to produce the localized additional magnetic force, and selects the winding or group of windings in which to feed the additional current; and control device 8 then acts on switch converter 30 of the selected winding 17 or group of windings 17 on the basis of the additional current calculated.

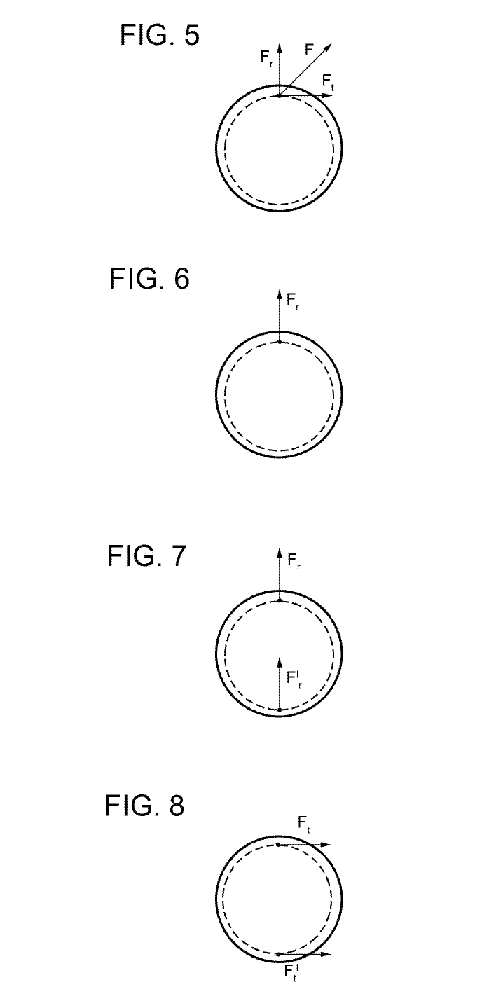

More specifically, as shown in FIG. 5, processing unit 32 of control device 8 divides the defined localized additional magnetic force F into a radial component Fr radial with respect to rotor 11, and a tangential component Ft tangent to rotor 11.

As stated, control device 8 determines the currents in groups of windings 17; which currents, and likewise the additional currents, are defined in a three-phase stationary coordinate system.

Utilizing processing unit 32, control device 8 is configured to process the currents and additional currents to convert the three-phase stationary coordinate system to a system of two movable coordinates, such as a system of two rotary coordinates integral with the rotor: an in-phase coordinate, and a quadrature coordinate perpendicular to the in-phase coordinate. In one embodiment, the in-phase coordinate is coincident with the axis of symmetry of the magnetic pole of rotor 11.

More specifically, processing unit 32 applies a Clarke transform followed by a Park transform to the currents to define an in-phase current representing the in-phase component of the movable-coordinate system, and a quadrature current representing the quadrature component of the movable-coordinate system. Likewise, processing unit 32 applies a Clarke transform followed by a Park transform to the additional currents to define an additional in-phase current representing the in-phase component of the movable-coordinate system, and an additional quadrature current representing the quadrature component of the movable-coordinate system.

The in-phase current and additional in-phase current define a magnetic field in phase with the magnetic excitation field, and the quadrature current and additional quadrature current define a magnetic field with a 90 electric degree phase shift with respect to the magnetic excitation field. So, disregarding iron saturation of the magnetic circuit of electric machine 6, and other secondary effects relating to the topology of electric machine 6, the in-phase current controls the magnetic excitation flux produced by magnetized modules 25 of rotor 11, and the quadrature current determines the resisting torque of electric machine 6.

The additional in-phase current defines the radial component Fr of the localized additional magnetic force associated with said additional current.

The additional quadrature current defines the tangential component Ft of the localized additional magnetic force associated with said additional current.

With reference to FIG. 6, after determining localized additional magnetic force F as a function of time, control device 8 defines the radial component Fr of localized additional magnetic force F as a function of time; calculates the additional in-phase current on the basis of radial component Fr of localized additional magnetic force F; selects a winding or group of windings 17; and acts on switch converter(s) 30 to feed the additional in-phase current to the selected winding 17 or group of windings 17. By so doing, stress on rotor 11 is balanced, the working life of rotor 11 and bearing assembly 9 is prolonged, and air gap 29 is prevented from decreasing to the point of stopping electric machine 6, thus avoiding costly breakdowns in service.

In an alternative embodiment shown in FIG. 7, control device 8 defines a further localized additional magnetic force F′ on the basis of the size and/or variation over time in the size of air gap 29; on the basis of localized additional magnetic force F, defines radial component Fr of localized additional magnetic force F, and a further radial component F′r of further localized additional magnetic force F′; calculates additional in-phase current on the basis of the radial component Fr of localized additional magnetic force F; calculates a further additional in-phase current on the basis of the further radial component F′r of further localized additional magnetic force F′; selects groups of windings 17; and acts on switch converters 30 to feed the additional in-phase current and further additional in-phase current to the selected groups of windings 17. By so doing, air gap 29 is prevented from decreasing to the point of stopping electric machine 6, thus resulting in costly breakdowns in service, and the working life of bearing assembly 9 is prolonged.

In an alternative embodiment shown in FIG. 8, after defining the localized additional magnetic force and further localized additional magnetic force, control device 8 defines tangential component Ft of localized additional magnetic force F, and a further tangential component F′t of a further localized additional magnetic force F′; calculates the additional quadrature current on the basis of tangential component Ft of localized additional magnetic force F; calculates a further additional quadrature current on the basis of further tangential component F′t of further localized additional magnetic force F′; selects windings 17 or groups of windings 17; and acts on switch converters 30 to feed the additional quadrature current and further additional quadrature current to the respective selected windings 17. By so doing, the air gap is prevented from decreasing below a given or designated point, the working life of bearing assembly 9 is prolonged, and stoppage of electric machine 6 and costly breakdowns in service are prevented.

In an alternative embodiment (not shown), the proximity sensors are eliminated, and the control device determines the size of the air gap without sensors. More specifically, the control device is configured to determine the size of the air gap on the basis of the voltage in the windings or the current and/or harmonic content of the voltage and/or currents.

In an alternative embodiment (not shown), the localized additional magnetic force is not defined on the basis of the size and/or variations in the size of the air gap, and the control device determines misalignment and/or the variation over time in misalignment of the rotor and stator, and defines a localized additional magnetic force on the basis of said misalignment and/or variations over time in said misalignment.

In an alternative embodiment (not shown), the further localized additional magnetic force is not defined on the basis of the size and/or variations over time in the size of air gap 29, and the control device defines a further localized additional magnetic force on the basis of the localized additional magnetic force, said misalignment, and/or variations over time in said misalignment.

Electric machine 6 described is a radial-flux permanent-magnet electric machine with buried permanent magnets, but the protective scope of the present disclosure also extends to any other type of permanent-magnet electric machine, such as a radial-flux electric machine with surface magnets, or an axial-flux or cross-flux electric machine. The protective scope of the present disclosure also extends to other synchronous electric machines, such as those with wound rotors; and to asynchronous electric machines (e.g., with squirrel-cage rotors). Moreover, the wind power turbine is a direct-drive type (i.e., with the hub and electric machine rotor connected directly to one another).

The present disclosure also covers embodiments not described in detail herein, and equivalent embodiments within the protective of the accompanying Claims. That is, various changes and modifications to the presently disclosed embodiments will be apparent to those skilled in the art. Such changes and modifications can be made without departing from the spirit and scope of the present subject matter and without diminishing its intended advantages. It is therefore intended that such changes and modifications be covered by the appended claims.

1-17. (canceled)

18. A method of controlling a wind power turbine including an electric machine which includes a stator, a rotor configured to rotate about an axis of rotation with respect to the stator, and a mechanical bearing assembly configured to rotatably couple the rotor to the stator, said stator including at least one winding configured to electromagnetically interact with the rotor, said method comprising:
determining a variation of a gap defined by the rotor and the stator;
determining a localized additional magnetic force based on the determined variation of the gap; and
correcting the determined variation of the gap using the determined localized additional magnetic force.

19. The method of claim 18, wherein determining the variation of the gap includes estimating the variation of the gap.

20. The method of claim 19, wherein the estimated variation of the gap is selected from the group consisting of: a distance between the rotor and the stator, a variation over time in said distance between the rotor and the stator, a misalignment between the rotor and the stator, and a variation over time in said misalignment between the rotor and the stator;

21. The method of claim 20, which includes estimating the misalignment between the rotor and the stator based on the distance between the rotor and stator.

22. The method of claim 18, wherein correcting the determined variation of the gap using the determined localized additional magnetic force includes feeding the at least one winding of the stator with an additional current determined based on the determined localized additional magnetic force.

23. The method of claim 22, which includes:
dividing the determined localized additional magnetic force into a radial component radial with respect to the rotor, and a tangential component tangential to the rotor; and
correcting the determined variation of the gap using the radial component of the determined localized additional magnetic force.

24. The method of claim 23, which includes:
dividing the additional current into an in-phase current and a quadrature current, each of said in-phase current and said quadrature current being associated with a rotary reference system integral with the rotor; and
controlling the in-phase current of the additional current to regulate the radial component of the determined localized additional magnetic force to correct the determined variation of the gap.

25. The method of claim 22, which includes:
determining a further localized additional magnetic force as a function of the determined variation of the gap;
dividing the determined further localized additional magnetic force into a radial component radial with respect to the rotor and a tangential component tangential to the rotor; and
correcting the determined variation of the gap using the radial component of the determined further localized additional magnetic force.

26. The method of claim 22, which includes:
determining a further localized additional magnetic force as a function of the determined variation of the gap;
dividing the determined localized additional magnetic force into a radial component radial with respect to the rotor and a tangential component tangential to the rotor;
dividing the determined further localized additional magnetic force into a radial component radial with respect to the rotor and a tangential component tangential to the rotor; and
correcting the determined variation of the gap using the tangential component of the determined localized additional magnetic force and the tangential component of the determined further localized additional magnetic force.

27. The method of claim 26, which includes:
feeding the at least one winding of the stator with a further additional current determined based on the determined further localized additional magnetic force;
dividing the additional current into an in-phase current and a quadrature current, each of said in-phase current and said quadrature current being associated with a rotary reference system integral with the rotor;
dividing the further additional current into a further in-phase current and a further quadrature current, each of the further in-phase current and the further quadrature current being associated with the rotary reference system integral with the rotor;
controlling the quadrature current to regulate a tangential component of the determined localized additional magnetic force; and
controlling the further quadrature current to regulate the tangential component of the determined further localized additional magnetic force to correct the determined variation of the gap.

28. A wind power turbine comprising:
an electric machine including:
a stator,
a rotor configured to rotate about an axis of rotation with respect to the stator, and
a mechanical bearing assembly configured to rotatably couple the rotor to the stator,
wherein said stator includes at least one winding configured to electromagnetically interact with the rotor; and
a control device configured to:
determine a variation of a gap defined by the rotor and the stator;
determine a localized additional magnetic force based on the determined variation of the gap; and
correct the determined variation of the gap using the determined localized additional magnetic force.

29. The wind power turbine of claim 28, wherein the determined variation of the gap includes an estimated variation of the gap.

30. The wind power turbine of claim 29, wherein the estimated variation of the gap is selected from the group consisting of: a distance between the rotor and the stator, a variation over time in said distance between the rotor and the stator, a misalignment between the rotor and the stator, and a variation over time in said misalignment between the rotor and the stator;

31. The wind power turbine of claim 30, wherein the estimated misalignment between the rotor and the stator is based on the distance between the rotor and stator.

32. The wind power turbine of claim 28, which includes a proximity sensor coupled to the control device and configured to detect a distance between the rotor and the stator.

33. The wind power turbine of claim 32, wherein the control device is configured to estimate a variation over time in the distance between the rotor and the stator based on the distance between the rotor and the stator detected by the proximity sensor.

34. The wind power turbine of claim 28, wherein the control device is coupled to the at least one winding and is configured to control, in the at least one winding, an additional current determined based on the determined localized additional magnetic force.

35. The wind power turbine of claim 34, wherein the control device is configured to:
divide the determined localized additional magnetic force into a radial component radial with respect to the rotor and a tangential component tangential to the rotor; and
correct the determined variation of the gap using the radial component of the determined localized additional magnetic force.

36. The wind power turbine of claim 35, wherein the control device is configured to:
divide the additional current into an in-phase current and a quadrature current, each of said in-phase current and said quadrature current being associated with a rotary reference system integral with the rotor; and
control the in-phase current of the additional current to regulate the radial component of the determined localized additional magnetic force to correct the determined variation of the gap.

37. The wind power turbine of claim 34, wherein the control device is configured to:
determine a further localized additional magnetic force as a function of the determined variation of the gap;
divide the determined further localized additional magnetic force into a radial component radial with respect to the rotor, and a tangential component tangential to the rotor; and
correct the determined variation of the gap using the radial component of the determined further localized additional magnetic force.

38. The wind power turbine of claim 34, wherein the control device is configured to:
determine a further localized additional magnetic force as a function of the determined variation of the gap;
divide the determined localized additional magnetic force into a radial component radial with respect to the rotor and a tangential component tangential to the rotor;
divide the determined further localized additional magnetic force into a radial component radial with respect to the rotor and a tangential component tangential to the rotor; and
correct the determined variation of the gap using the tangential component of the determined localized additional magnetic force and the tangential component of the determined further localized additional magnetic force.

39. The wind power turbine of claim 38, wherein the control device is configured to:
feed the at least one winding of the stator with a further additional current determined based on the determined further localized additional magnetic force;
divide the additional current into an in-phase current and a quadrature current, each of the in-phase current and the quadrature current being associated with a rotary reference system integral with the rotor;
divide the determined further additional current into an in-phase current and a quadrature current, each of the in-phase current and the quadrature current being associated with the rotary reference system integral with the rotor; and
control the quadrature current to regulate a tangential component of the determined localized additional magnetic force and the quadrature current of the further additional current, and regulate the tangential component of the determined further localized additional magnetic force to correct the determined variation of the gap.

40. The wind power turbine of claim 28, wherein the rotor includes a plurality of magnetized modules configured to electromagnetically interact with the at least one winding of the stator.

41. A wind power turbine comprising:
an electric machine including:
a stator,
a rotor configured to rotate about an axis of rotation with respect to the stator, and
a mechanical bearing assembly configured to rotatably couple the rotor to the stator,
wherein said stator includes at least one winding configured to electromagnetically interact with the rotor; and
a control device configured to correct a position of the rotor relative to the stator by feeding the at least one winding of the stator with an additional current based on an additional magnetic force.

42. The wind power turbine of claim 41, wherein the control device is configured to determine the additional magnetic force based on the position of the rotor relative to the stator.
